(19) United States
(12) Patent Application Publication
(10) Pub. No.: US 2011/0230804 A1
(43) Pub. Date: Sep. 22, 2011

(54) Apparatus for stimulating fresh skin

(76) Inventor: Haitam Yousef Serhan, Salem, MA (US)

(21) Appl. No.: 12/931,180

(22) Filed: Jan. 26, 2011

Related U.S. Application Data
(60) Provisional application No. 61/340,743, filed on Mar. 20, 2010.

(51) Int. Cl. A61H 7/00; A61H 15/00

(52) U.S. Cl. 601/112; 601/137

(57) ABSTRACT

A portable handheld apparatus for stimulating and massaging any type of skin. A rotating drum on the head of the apparatus contains protruding spikes that may have a variety of shapes. These spikes contact the external surface of skin as the drum rotates, thereby removing dry or dead skin cells, removing makeup, unclogging pores and increasing blood flow to skin layers.

### CROSS REFERENCE TO RELATED APPLICATION

This application claims priority to U.S. Provisional Patent Application No. 61/340,743 filed on Mar. 20, 2010, the contents of which are incorporated herein by reference.

### FIELD OF THE INVENTION

This invention relates to a novel apparatus for stimulating and massaging skin to remove dry or dead skin cells, remove makeup, unclogged pores and increase blood flow to skin layers.

### BACKGROUND OF INVENTION

Skin is the largest organ of the human body. For skin cells to stay healthy, pores on the skin surface should have a normal flow of bodily secretions of oils, sweats and proteins.

Many different types of debris on the skin surface may prevent or clog pores, resulting in undesirable acne, blackheads, in-grown hairs or other skin afflictions. This debris may include internally produced products, such as oils, sweats, hair follicles or dead skin cells. This debris may also include external factors, such as applied makeup, lotions, bacterial cells, dirt or grime.

There is a need for an effective and inexpensive apparatus that can safely and gently remove these layers of debris from any place on the human body. In addition, any such device must be able to act on different skin types, such as young skin, old skin, thicker skin or thinner skin. Removal of this debris will increase normal pore flow on the skin surface and increase blood flow near the surface, resulting in healthier skin.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a handheld electric apparatus for contacting skin comprising: a housing having a head end; a motor contained within the housing, wherein the motor is operationally coupled to a drive shaft within the housing; a power source for operating the motor contained within the housing; a user-actuated switch for engaging the motor on the exterior of the housing; a substantially cylindrical drum rotatably attached on the head end of the housing; a plurality of abrasive protrusions on the external surface of the drum; and wherein the drum is operationally coupled to the drive shaft such that rotation of the drive shaft by the motor drives rotation of the drum in a direction substantially perpendicular to the head end of the housing, further wherein the plurality of abrasive protrusions contact selected areas of skin and each protrusion is capable of removing varying amounts of dry skin.

Another embodiment of the subject invention is a handheld electric apparatus for contacting skin comprising: a housing having a head end; a motor contained within the housing, wherein the motor is operationally coupled to a transmission within the housing; a power source for operating the motor contained within the housing; a user-actuated switch for engaging the motor on the exterior of the housing; a substantially cylindrical drum mounted between two arms extending from the head end in a substantially parallel direction with the housing such that the drum may freely rotate; a plurality of non-cutting protrusions on the external surface of the drum; and wherein the transmission comprises transmitting means for transmitting drive from the motor to drive rotation of the drum in a direction substantially perpendicular to the head end of the housing, further wherein the plurality of non-cutting protrusions contact selected areas of skin, wherein each protrusion comprises a skin contacting surface that is abrasive but cannot cut through hair follicles or cut living skin.

A further embodiment of the subject invention is a handheld electric apparatus for contacting skin comprising: a housing having a head end; a motor contained within the housing, wherein the motor is operationally coupled to a drive shaft within the housing; a power source for operating the motor contained within the housing; a user-actuated switch for engaging the motor on the exterior of the housing; a substantially cylindrical drum rotatably mounted on the head end; a plurality of non-cutting protrusions on the external surface of the drum; and wherein the drum is operationally coupled to the drive shaft such that rotation of the drive shaft drives rotation of the drum in a direction substantially perpendicular to the head end of the housing, wherein the plurality of non-cutting protrusions contact selected areas of skin, wherein each protrusion comprises a skin contact edge that is abrasive but cannot cut through a hair follicle or cut living skin.

An additional embodiment of the subject invention is a handheld electric apparatus for contacting skin comprising: a housing having a head end; a motor contained within the housing, wherein the motor is operationally coupled to a drive shaft within the housing; a power source for operating the motor contained within the housing; a user-actuated switch for engaging the motor on the exterior of the housing; a substantially cylindrical drum rotatably attached on the head end between two arms extending from the head end in a substantially parallel direction with the housing such that the drum may freely rotate in either direction; a plurality of abrasive protrusions on the external surface of the drum; wherein the drum is operationally coupled to the transmission or drive shaft such that rotation of the drive shaft drives rotation of the drum in a direction substantially perpendicular to the head end of the housing; and wherein after the motor is engaged, the plurality of abrasive protrusions contact selected areas of skin, further wherein each protrusion comprises a skin contact surface or skin contact edge that is capable of removing varying amounts of dry skin, dead skin, makeup, facial oils, dirt, bacteria but is not sharp enough to cut through hair follicles.

In other embodiments of the subject invention, the housing may comprise one or more vibration elements operationally coupled to the power source and transmitting means for transmitting vibration from the motor to drive vibration of the drum upon engagement of the motor.

In a further embodiment of the subject invention the drum may be removably attached to the head end of the housing for interchanging drums with worn down protrusions or interchanging drums with different sized or shaped protrusions.

In an additional embodiment of the subject invention, the head end may be removably attached to the housing for interchanging drums with worn down protrusions or interchanging drums with different sized or shaped protrusions.

In another embodiment of the subject invention, the rotation of the drum may change to several selected speeds.

In an additional embodiment of the subject invention, the drum may be composed of a material selected from the group consisting of hard rubber, soft rubber, and soft plastic.

In a further embodiment of the subject invention, the drum may be ½ inch to eight inches in length. In another embodiment of the subject invention, the drum may be ¼ inch to two inches in diameter.

In an additional embodiment of the subject invention, each of the plurality of protrusions may have a cross-sectional shape from the group consisting rectangular, oval, diamond, trapezoidal, square, circular, triangular, octagonal or hexagonal.

In a further embodiment of the subject invention, the power source may be an internal battery. In an additional embodiment of the subject invention, the power source may have cord attached thereto for selectively connecting to an electrical outlet. In this embodiment, the power source may be a rechargeable battery.

The subject invention further discloses a kit for treating dry skin comprising: a handheld housing; a motor contained within the housing, wherein the motor is operationally coupled to a drive shaft within the housing; an electrical power source for operating the motor contained within the housing; a user-actuated switch for engaging the motor on the exterior of the housing; at least two head ends interchangeably attachable to the housing; a substantially cylindrical drum rotatably attached to each interchangeable head end, wherein the drum on each interchangeable head end comprises a plurality of abrasive external protrusions; and wherein once a head end is attached to the housing, the drum is operationally coupled to the drive shaft such that rotation of the drive shaft by the motor drives rotation of the drum in a direction substantially perpendicular to the head end of the housing, further wherein the plurality of abrasive protrusions contact selected areas of skin and each protrusion is capable of removing varying amounts of dry skin.

In another embodiment of the subject invention, each interchangeable head end may comprise a plurality of abrasive external protrusions with a different size that the plurality of abrasive external protrusions on the other interchangeable head ends.

In a further embodiment of the subject invention, each interchangeable head end may comprise a plurality of abrasive external protrusions with a different cross-sectional shape that the plurality of abrasive external protrusions on the other interchangeable head ends.

In one embodiment of the subject invention, the kit may further include a third head end interchangeably attachable to the housing, wherein the third head end comprises a hair shaver or hair remover, further wherein once the third head end is attached to the housing, the hair shaver or hair remover is operationally coupled to the drive shaft such that rotation of the drive shaft by the motor drives operation of the hair shaver or hair remover.

Another embodiment of the subject invention, is a kit for treating dry skin comprising: a handheld housing having a head end; a motor contained within the housing, wherein the motor is operationally coupled to a drive shaft within the housing; an electrical power source for operating the motor contained within the housing; a user-actuated switch for engaging the motor on the exterior of the housing; at least two substantially cylindrical drums interchangeably attachable to the head end, wherein each interchangeable drum comprises a plurality of abrasive external protrusions; and wherein once a drum is attached to the head end, the drum is operationally coupled to the drive shaft such that rotation of the drive shaft by the motor drives rotation of the drum in a direction substantially perpendicular to the head end of the housing, further wherein the plurality of abrasive protrusions contact selected areas of skin and each protrusion is capable of removing varying amounts of dry skin.

In an additional embodiment of the subject invention, each interchangeable drum may comprise a plurality of abrasive external protrusions with a different size that the plurality of abrasive external protrusions on the other interchangeable drums.

In a further embodiment of the subject invention, each interchangeable drum may comprise a plurality of abrasive external protrusions with a different cross-sectional shape that the plurality of abrasive external protrusions on the other interchangeable drums.

In one embodiment of the subject invention, the kit may further include a third head end interchangeably attachable to the housing, wherein the third head end comprises a hair shaver or hair remover, further wherein once the third head end is attached to the housing, the hair shaver or hair remover is operationally coupled to the drive shaft such that rotation of the drive shaft by the motor drives operation of the hair shaver or hair remover.

Another embodiment of the subject invention, is a kit for treating dry skin comprising: a handheld housing having a head end; a motor contained within the housing, wherein the motor is operationally coupled to a transmission within the housing; an electrical power source for operating the motor contained within the housing; a user-actuated switch for engaging the motor on the exterior of the housing; at least two substantially cylindrical drums interchangeably attachable to the head end in a substantially parallel direction with the housing such that the drum may freely rotate, wherein each interchangeable drum comprises a plurality of non-cutting protrusions; and wherein once a drum is attached to the head end, the transmission comprises transmitting means for transmitting drive from the motor to drive rotation of the drum in a direction substantially perpendicular to the head end of the housing, further wherein the plurality of non-cutting protrusions contact selected areas of skin, wherein each protrusion comprises a skin contacting surface that is abrasive but cannot cut through hair follicles.

In an additional embodiment of the subject invention, each interchangeable drum may comprise a plurality of non-cutting protrusions with a different size that the plurality of non-cutting protrusions on the other interchangeable drums.

In a further embodiment of the subject invention, each interchangeable drum may comprise a plurality of non-cutting protrusions with a different cross-sectional shape that the plurality of non-cutting protrusions on the other interchangeable drums.

In one embodiment of the subject invention, the kit may further include a third head end interchangeably attachable to the housing, wherein the third head end comprises a hair shaver or hair remover, further wherein once the third head end is attached to the housing, the hair shaver or hair remover is operationally coupled to the drive shaft such that rotation of the drive shaft by the motor drives operation of the hair shaver or hair remover.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated embodiments of the invention. Other features and advantages of the present invention will become apparent from the following description of the embodiment(s), taken in conjunction with the accompanying drawings, which illustrate, by way of example, the principles of the invention.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a front view of one embodiment of the skin stimulating apparatus with a removable head.

FIG. 2 illustrates a side view of one embodiment of the skin stimulating apparatus with a removable head.

FIG. 3 illustrates a front view of one embodiment of a removable head of the skin stimulating apparatus that contains a rotating drum with oval-shaped spikes.

FIG. 4 illustrates a front view of one embodiment of a removable head of the skin stimulating apparatus that contains a rotating drum with diamond-shaped spikes.

FIG. 5 illustrates a cross sectional side view of one embodiment of the rotating drum of the skin stimulating apparatus with diamond-shaped spikes.

FIG. 6 illustrates a perspective view of one embodiment of the rotation mechanism for the rotating drum of the skin stimulating apparatus.

FIG. 7 illustrates a front cross-sectional view of another embodiment of the rotation mechanism for the rotating drum of the skin stimulating apparatus.

FIG. 8 illustrates a side cross-sectional view of an additional embodiment of the rotation mechanism for the rotating drum of the skin stimulating apparatus.

FIG. 9 illustrates a front view of another embodiment of the skin stimulating apparatus without a removable head.

FIG. 10 illustrates a front view of an additional embodiment of the skin stimulating apparatus with a removable head.

FIG. 11 illustrates a front view of the additional embodiment of a removable head of the skin stimulating apparatus that contains a rotating drum with oval-shaped spikes.

### DETAILED DESCRIPTION OF THE PREFERRED EMBODIMENTS

While several variations of the present invention have been illustrated by way of example in particular embodiments, it is apparent that further embodiments could be developed within the spirit and scope of the present invention, or the inventive concept thereof. It is to be expressly understood that such modifications and adaptations are within the spirit and scope of the present invention, and are inclusive, but not limited to the following appended claims as set forth.

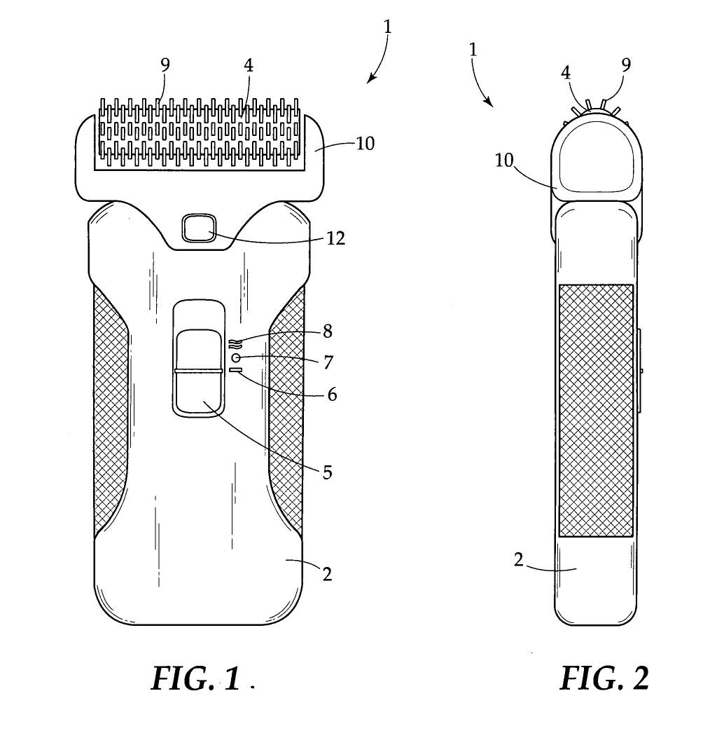

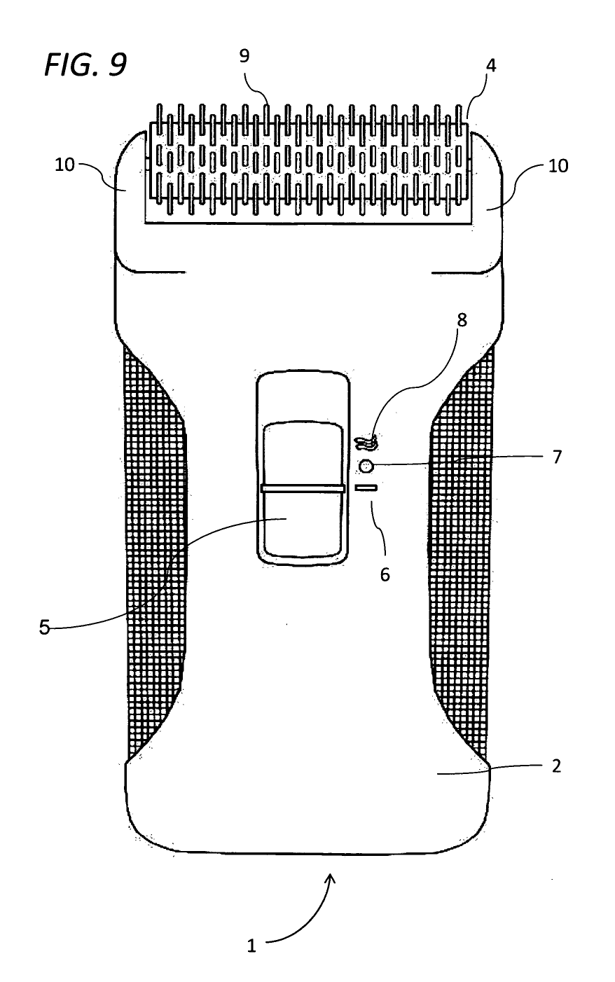

FIGS. 1, 2, 9 and 10 illustrate embodiments of the skin stimulating apparatus 1 of the subject invention. Apparatus 1 is a portable handheld device, substantially the size of other handheld electric devices.

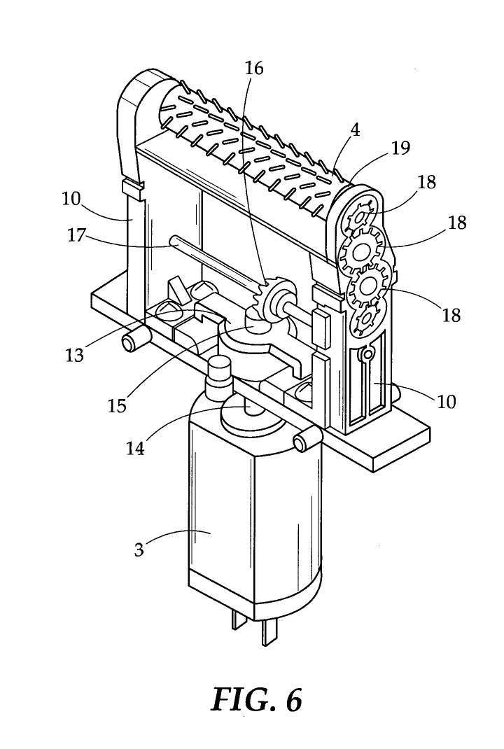

The apparatus 1 includes a housing 2 that encloses a motor 3, a drive mechanism (embodiments of which are shown in FIGS. 6-8) for rotating drum 4, a vibration mechanism and a power supply. In embodiments of the subject invention, motors may include any small electrical motors for generating rotational force used in electric hair razors, as known to those skilled in the art.

In this embodiment, housing 2 also has a user-actuated power switch 5. In embodiments of the subject invention, switch 5 may have multiple selections that may include, but are not limited to, providing power to rotate 6 drum 4, power to vibrate 7 drum 4, or providing both 8. In this embodiment, a user may either vibrate or rotate drum 4 separately or at the same time. In embodiments of the subject invention, the drum 4 may be rotated at several user-selected speeds. In other embodiments of the subject invention, the switch 5 may have selections to rotate drum 4 in a forward or reverse direction.

In one embodiment of the subject invention, the rotating and vibrating mechanisms of apparatus 1 may be operational coupled to a power supply that may have a cord (not shown) attached thereto for selectively connecting to an electrical outlet. In another embodiment of the subject invention, the rotating and vibrating mechanisms of apparatus 1 may be operational coupled to a power supply that may be an internal rechargeable battery (not shown) to allow apparatus 1 to operate cordlessly.

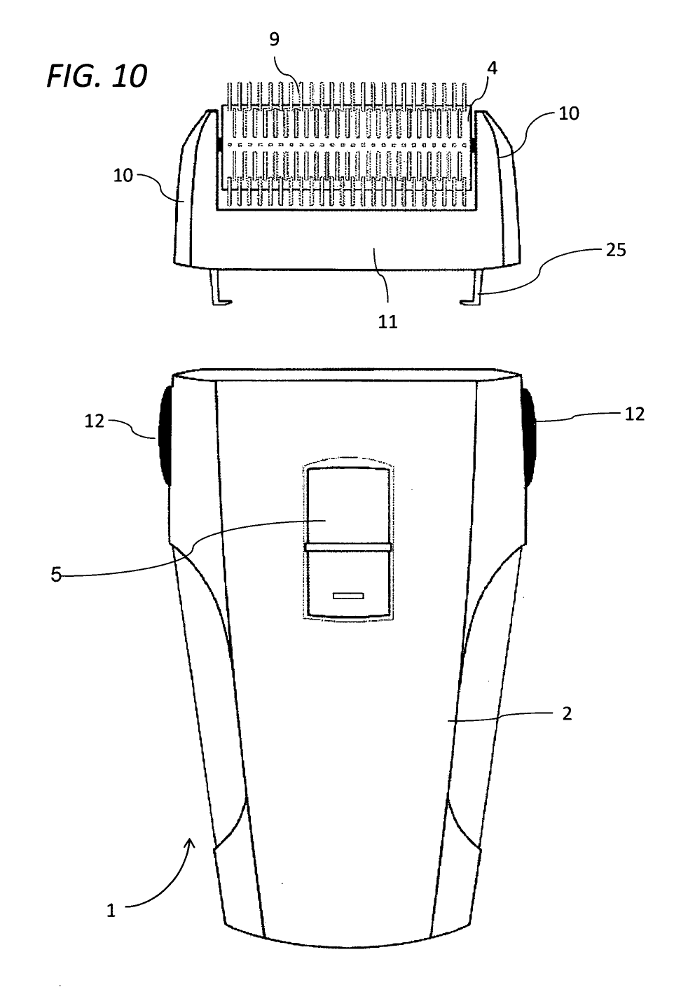

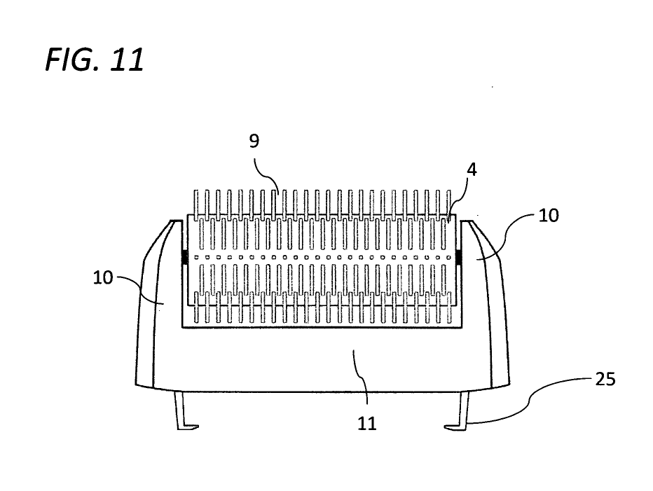

The embodiments of apparatus 1 in FIGS. 1, 2 and 10 illustrate a removable head 11. This head 11 may be removably attached to housing 2 with clips 25, as shown in FIG. 10. In this embodiment, head 11 may be removed from apparatus 1 by pressing one or more buttons 12. In one embodiment of the subject invention, head 11 may be replaced with a standard electric shaver head or hair remover (not shown). In one embodiment of the subject invention, the head 11 may be enclosed with a snap-fit plastic cover or shield when not in use.

Both sides of head 11 have protruding arms 10 that contain a substantially cylindrical rotating drum 4 with a plurality of protruding spikes 9. Drum 4 is contained within arms 10 such that drum 4 may freely rotate in either direction.

In one embodiment of the subject invention, rotatable drum 4 may be removably attached to arms 10. A removably attachable drum 4 may allow a user to replace a worn drum 4 or interchange drums with different shapes of spikes 9. In other embodiments of the subject invention the entire head 11 may be replaced for a worn drum 4 or to interchange drums with different shapes of spikes 9. Embodiments of the subjection invention include kits that include one apparatus 1 and multiple drums 4 or heads 11 with different shapes of spikes 9.

In embodiments of the subject invention, drum 4 may be composed of a hard rubber or other rigid, but flexible material, such as a soft plastic. In embodiments of the subject invention, drum 4 may be ½ inch to eight inches in length and ¼ to 2 inches in diameter.

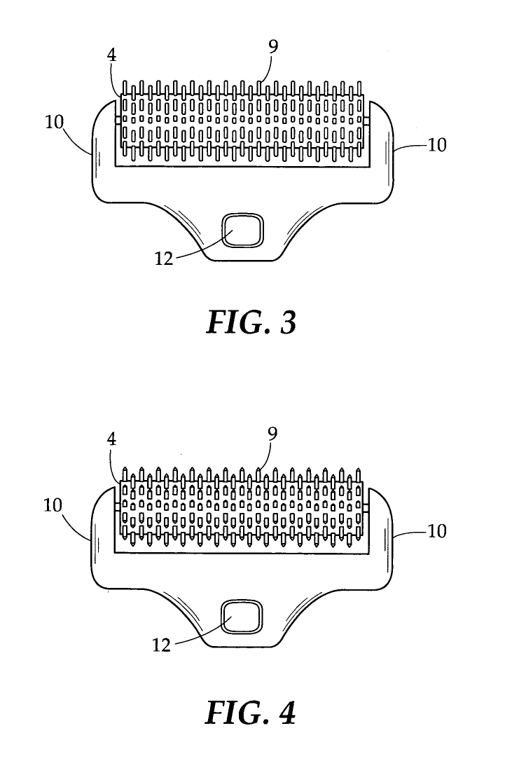

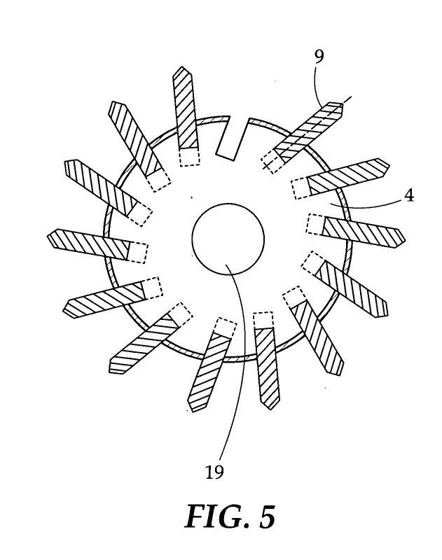

Drum 4 contains a plurality of protruding spikes 9 on the external surface for contacting skin surfaces. In embodiments of the subject invention, spikes 9 may have a variety of shapes, including rectangular-shaped spikes (as shown in FIGS. 1 and 2), oval-shaped spikes (as shown in FIGS. 3, 5 and 8) or diamond-shaped spikes (as shown in FIG. 4). In embodiments of the subject invention, spikes 9 may also have other shapes including, but not limited to: trapezoid, square, circle, triangle, octagon or hexagon (not shown). In one embodiment of the subject invention, a plurality of drums 4, each with differently shaped spikes 9 may be included in a kit with apparatus 1.

Once a user activates the rotation of drum 4; drum 4 rotates in a substantially vertical direction. The user brings the rotating drum 4 into contact with his or her skin surface. Spikes 9 sweep the skin surface to remove dead skin cells, make-up, bacterial cells, oils, dirt, grime, and lotions. This removal prevents skin pores from clogging and promotes a healthy skin surface.

In embodiments of the subject invention, drum 4 may be cleaned by submersion in an alcohol or hydrogen peroxide solutions, steam decontamination, or heat sterilization (such as autoclaves).

FIG. 6 illustrates one embodiment of the rotation mechanism 13 for rotating drum 4 of skin stimulating apparatus 1. In this embodiment, electrical motor 3 provides rotational force to a drive shaft 14. Drive shaft 14 is coupled to and rotates a spur gear 15. Spur gear 15 is coupled to and rotates a crown gear 16. Crown gear 16 is attached to a rotation shaft 17, which rotates as crown gear 16 is rotated by spur gear 15. Shaft 17 is coupled to substantially vertical gears (not shown) in one or both arms 10 which are coupled to and rotate substantially vertical coupled gears 18. In embodiments of the subject invention, the drive mechanism 13 of drum 4 may have one to five substantially vertical coupled gears 18. One gear 18 is attached to one or both sides of the rotating drum 4 and rotates drum 4. In other embodiments of the subject invention, gear 18 is attached to internal spindle 19 within drum 4.

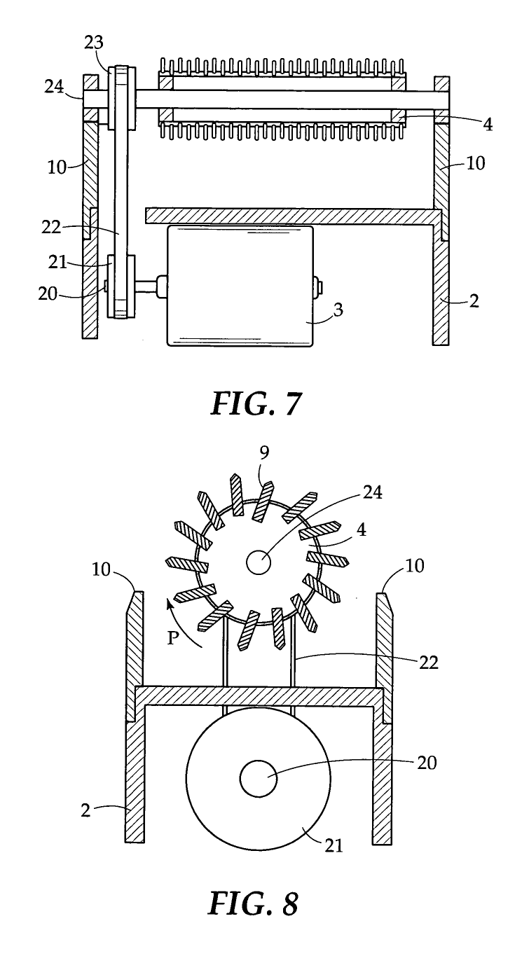

FIGS. 7 and 8 illustrate another embodiment of the rotation mechanism for the rotating drum of the skin stimulating apparatus. In this embodiment, electrical motor 3 provides rotational force to a drive shaft 20, which is attached to a lower pulley wheel 21. As wheel 21 rotates, it pulls drive belt 22 within arm 10, which rotates an attached upper pulley wheel 23. Wheel 23 is attached to a rotating shaft 24 within rotating drum 4. In other embodiments of the subject invention, there may be an additional pulley system in the other arm 10.

In embodiments of the subject invention, other drive mechanisms may be used for transferring rotational force to the rotating drum 4, as known to those skilled in the art.

What is claimed is:

1. A handheld electric apparatus for contacting skin comprising:
a housing having a head end;
a motor contained within the housing, wherein the motor is operationally coupled to a drive shaft within the housing;
a power source for operating the motor contained within the housing;
a user-actuated switch for engaging the motor on the exterior of the housing;
a substantially cylindrical drum rotatably attached on the head end of the housing;
a plurality of abrasive protrusions on the external surface of the drum; and
wherein the drum is operationally coupled to the drive shaft such that rotation of the drive shaft by the motor drives rotation of the drum in a direction substantially perpendicular to the head end of the housing, further wherein the plurality of abrasive protrusions contact selected areas of skin and each protrusion is capable of removing varying amounts of dry skin.

2. (canceled)

3. (canceled)

4. The invention of claim 1, wherein the housing further contains a vibration element operationally coupled to the power source and transmitting means for transmitting vibration from the motor to drive vibration of the drum upon engagement of the motor.

5. The invention of claim 1, wherein the drum is removably attached to the head end of the housing.

6. The invention of claim 1, wherein the head end is removably attached to the housing.

7. The invention of claim 1, wherein the rotation of the drum in a direction substantially perpendicular to the head end of the housing may be at several selected speeds.

8. The invention of claim 1, wherein the drum is composed of a material selected from the group consisting of hard rubber, soft rubber, and soft plastic.

9. The invention of claim 1, wherein the drum is ½ inch to eight inches in length.

10. The invention of claim 1, wherein the drum is ¼ inch to two inches in diameter.

11. The invention of claim 1, wherein each of the plurality of protrusions has a cross-sectional shape from the group consisting rectangular, oval, diamond, trapezoidal, square, circular, triangular, octagonal or hexagonal.

12. The invention of claim 1, wherein the power source is an internal battery.

13. The invention of claim 1, wherein the power source has a cord attached thereto for selectively connecting to an electrical outlet.

14. A kit for treating dry skin comprising:
a handheld housing;
a motor contained within the housing, wherein the motor is operationally coupled to a drive shaft within the housing;
an electrical power source for operating the motor contained within the housing;
a user-actuated switch for engaging the motor on the exterior of the housing;
at least two head ends interchangeably attachable to the housing;
a substantially cylindrical drum rotatably attached to each interchangeable head end, wherein the drum on each interchangeable head end comprises a plurality of abrasive external protrusions; and
wherein once a head end is attached to the housing, the drum is operationally coupled to the drive shaft such that rotation of the drive shaft by the motor drives rotation of the drum in a direction substantially perpendicular to the head end of the housing, further wherein the plurality of abrasive protrusions contact selected areas of skin and each protrusion is capable of removing varying amounts of dry skin.

15. The invention of claim 14, wherein each interchangeable head end comprises a plurality of abrasive external protrusions with a different size that the plurality of abrasive external protrusions on the other interchangeable head ends.

16. The invention of claim 14, wherein each interchangeable head end comprises a plurality of abrasive external protrusions with a different cross-sectional shape that the plurality of abrasive external protrusions on the other interchangeable head ends.

17. A kit for treating dry skin comprising:
a handheld housing having a head end;
a motor contained within the housing, wherein the motor is operationally coupled to a drive shaft within the housing;
an electrical power source for operating the motor contained within the housing;
a user-actuated switch for engaging the motor on the exterior of the housing;
at least two substantially cylindrical drums interchangeably attachable to the head end, wherein each interchangeable drum comprises a plurality of abrasive external protrusions; and
wherein once a drum is attached to the head end, the drum is operationally coupled to the drive shaft such that rotation of the drive shaft by the motor drives rotation of the drum in a direction substantially perpendicular to the head end of the housing, further wherein the plurality of abrasive protrusions contact selected areas of skin and each protrusion is capable of removing varying amounts of dry skin.

18. The invention of claim 17, wherein each interchangeable drum comprises a plurality of abrasive external protrusions with a different size that the plurality of abrasive external protrusions on the other interchangeable drums.

19. The invention of claim 17, wherein each interchangeable drum comprises a plurality of abrasive external protrusions with a different cross-sectional shape that the plurality of abrasive external protrusions on the other interchangeable drums.
